(19) United States
(12) Patent Application Publication
(10) Pub. No.: US 2011/0211633 A1
(43) Pub. Date: Sep. 1, 2011

(54) LIGHT CHANGE CODING

(76) Inventors: Ferran Valldosera, (US); Hua Yang, Princeton, NJ (US); Alan Jay Stein, Princeton, NJ (US)

(21) Appl. No.: 13/128,724

(22) PCT Filed: Nov. 10, 2009
(86) PCT No.: PCT/US09/06042

§ 371 Date: May 11, 2011

(30) Foreign Application Priority Data
Nov. 12, 2008 (US) 61/199011

(51) Int. Cl. H04N 7/26

(52) U.S. Cl. 375/240.01; 375/E07.026

(57) ABSTRACT

An encoding methodology for a video encoder encodes target light change (TLC) frames in order to improve the quality of the resulting decoded video. Backward prediction is applied instead of forward prediction to the frames that are detected as TLC frames. Additionally, the last frame of the TLC activity is forced to use only intra-coding modes.

### FIELD OF THE INVENTION

The invention is related to a method for encoding video frames containing certain types of light changes and more particularly to such a method using backward prediction.

### BACKGROUND OF THE INVENTION

In general, light changes in a video sequence are difficult to encode and usually lead to a degradation in subjective video quality in the resulting decoded video. This is due to a limitation of the motion compensation's ability to produce a good prediction of a frame in which a light change occurs, as only motion is generally taken into account. To solve this problem some video encoders use weighted prediction, in which a weighting factor and an offset factor are computed and applied to the motion compensated frame to improve the reference prediction frame used for encoding.

However, there are certain types of light changes that are very difficult to encode. These types of light changes start with a strong light intensity condition followed by a progressive reduction of light intensity revealing the visual content. For the reverse it starts with very low light intensity followed by a progressive increase of light intensity to reveal the visual content of the particular scene.

A definition encompassing both cases may be expressed using information theory concepts as self-information or entropy. In that case, a target light change might be defined as a set of frames where the amount of information content (or self-information), is progressively increased along the frames involved in the light change activity. See FIG. 1 for an example of a light change. Canonical examples include black fade in and white fade in frame sequences. Referring to FIG. 1, in a black fade in, a certain group of consecutive frames starts with a black frame, 19 (or nearly black) and during the following frames 20, 21, 22 and 23, it progressively increases the light intensity of those frames up to a particular contrast, considered as the end of the fade activity. In a white fade in, also known as flash in, a certain group of consecutive frames starts with a white frame (or nearly white) in place of the black frame and during the following frames it progressively decreases the light intensity of those frames to a particular contrast, considered as the end of the fade activity. These types of light changes that satisfy the definition above will be denoted as a target light change or TLC.

The Forward Prediction coding mode in a video encoder is the default mode used for motion estimation and motion compensation. In MPEG based video standards, they are represented by P frames and they are generated by predicting from previous I or previous P frames. For TLC light changes, the use of forward prediction coding mode may produce quality artifacts in the reconstructed video. Intuitively this may be apparent, as the prediction comes from a frame with higher detail (higher information content) than the one used as the reference for the prediction. In practice, if forward prediction is applied to TLC frames, the results are either bad inter-frame prediction or in an inefficient use of Intra mode to encode these frames. Consequently, in a constant bitrate (CBR) coding scenario, the TLC frames show lower subjective quality than non-TLC frames. On the other hand, if reverse coding order is employed for TLC frames in combination with weighted prediction, more accurate prediction may be produced to encode such frames.

Attempts to cope with generic light change activities have generally been addressed with weighted prediction techniques. These attempts generally compute the weighted prediction parameters such that applying them to the motion compensated frame can effectively reduce the artifacts due to light change frames.

### SUMMARY OF THE INVENTION

An encoding methodology is provided for a video encoder to encode TLC frames in order to improve the quality of the resulting decoded video. Backward prediction is applied instead of forward prediction to the frames that are detected as TLC frames. Additionally, the last detected TLC frame (in display order) is enforced to use only intra-coding modes.

A method of encoding a series of video frames is provided which comprising detecting a light change pattern in the series beginning with an extreme light frame; buffering the series of frames; selecting an end light change frame in the series, the end light change frame having more information content than the extreme light frame; and encoding frames backward from the end of light change frame to the extreme light frame. The extreme light frame can be a black or substantially black frame or a white or substantially white frame. The end light change frame can be coded by an intra-coding mode. The number of frames buffered can depends upon the size of a buffer and/or the number of frames buffered depends upon a maximum number of frames allowed in a group of pictures.

An apparatus is provided which is adapted to generate or receive a signal comprising a series of encoded video frames; encoded by detecting a light change pattern in the series beginning with an extreme light frame; selecting an end light change frame in the series, the end light change frame having more information content than the extreme light frame; and encoding the frames backward from the end of light change frame to the extreme light frame. The signal can represent digital information and can be in the form of an electromagnetic wave. The signal can be a baseband signal.

A device is provided which is capable of encoding video frames comprising: a pre-analysis module having a light change detection apparatus; an encoding module having a group of pictures (GOP) pattern decision sub-module which establishes a coding order and a display order for the frames belonging to the GOP such that, a backward prediction coding order is set for frames detected by the pre-analysis module as having a light change.

### BRIEF DESCRIPTION OF THE DRAWINGS

The invention will now be described by way of example with reference to the accompanying figures of which:

FIG. 1 is a series of video frames having a light change;

FIG. 2 is a block diagram of an encoding system according to the invention;

FIG. 3 is a schematic showing a frame encoding method according to the invention;

FIG. 4 is also a schematic showing a frame encoding method according to the invention; and,

FIG. 5 is also a schematic showing a frame encoding method according to the invention.

### DETAILED DESCRIPTION OF THE INVENTION

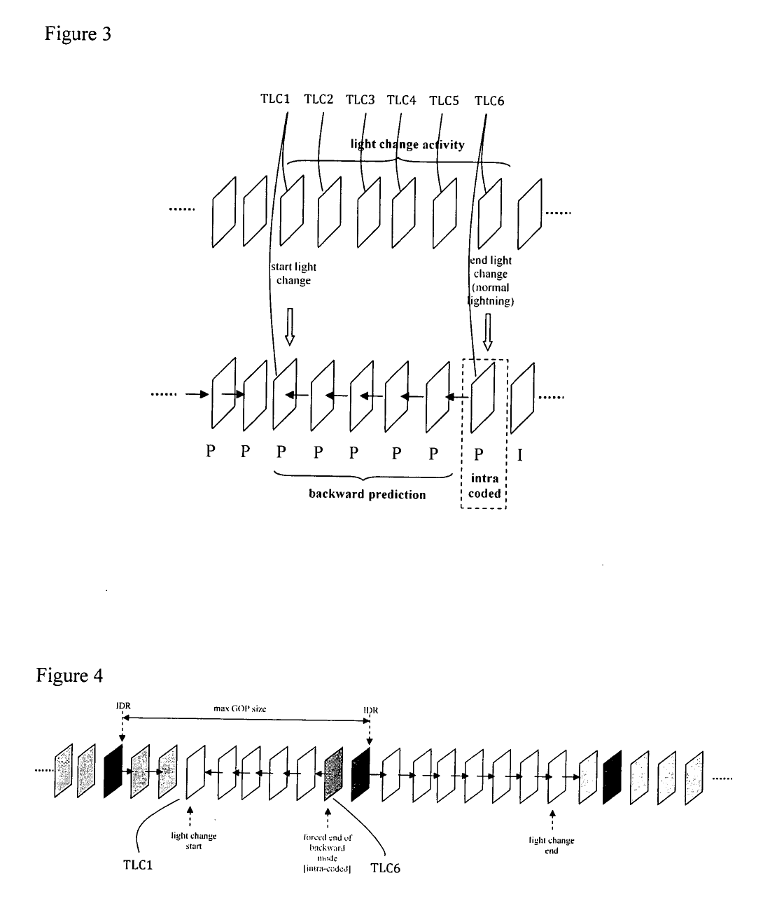

FIG. 2 represents a simplistic video encoder 25 block diagram comprising pre-analysis and encoding modules 30,40 which will be described in greater detail in the following paragraphs.

The pre-analysis module 30 has a light change detection algorithm 32 that identifies those frames 19-23 involved in a light change and marks them with a special flag indicating the type of light change that they belong to. It is assumed that frames classified as being part of a light change can be marked as such and made known to the encoder 25. These frames 19-23 are later used to improve the prediction of the motion compensated frame. It is worth noting that implementations for light change coding described here work independently of the algorithm used for the light change detection. The light change algorithm, although described here as being a part of the pre-analysis module does not need to reside in a pre-analysis module. It can alternatively reside within the encoder depending on its implementation or may be part of an external module that gathers metadata for the frames to be encoded.

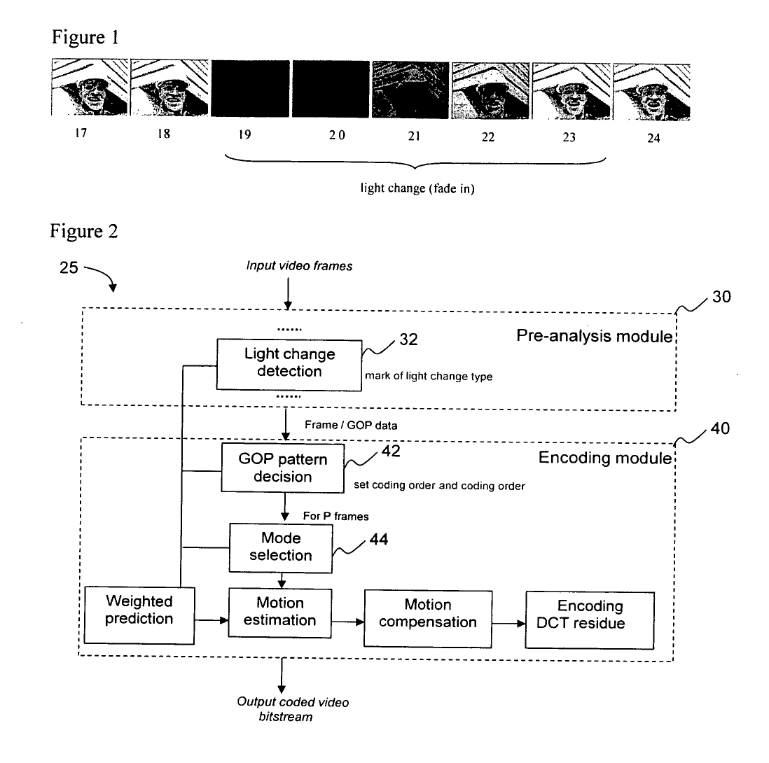

The method includes, as a first step, forcing the last detected TLC frame, 23 in FIG. 1 or TLC6 in FIG. 3, to be encoded only with intra-coding modes. The decision is made in the mode selection module 44. The mode selection 44 checks for light activity flags to see if the current frame is the last of a series of detected TLC frames. In that case it disables all coding modes except for intra-coding modes. Exhaustive experiments showed that if this enforcement was not done, the frame(s) used to produce the prediction are overly temporally distant which results in poor prediction. The longer the light change is in terms of number of frames involved, the poorer the quality of the prediction may be if this technique was not used. Therefore, encoding this frame with only intra-coding modes achieves higher quality given the circumstances of this type of sequence.

In the example of FIG. 2, the group of pictures (GOP) pattern decision sub-module 42 establishes the coding order and the display order for all frames belonging to the GOP. It is in this sub-module 42 where the second step takes place. This sub-module 42 now takes the information collected in the light change detection into account and for the detected TLC frames a backward prediction coding order between TLC6 and TLC1 in FIG. 3 is set. The consequence of this GOP pattern decision is that the encoder will precisely follow the defined coding order and any TLC frames (i.e. TLC1-TLC6) will automatically be encoded using backward prediction. This method is desirable as it does not require modification to any other video encoder modules. FIG. 3 shows how the GOP pattern decision assigns the use of backward prediction in a TLC activity. In FIGS. 3-5 it should be noted that TLC frames 19-23 are referred to as TLC1 . . . TLCn.

For the application to an H.264/AVC video encoder, there are two different limits for the maximum length of a series of frames being backward predicted.

The first limit is related to the Decoded Picture Buffer (DPB). The size of the DPB buffer forces a maximum length for a series of frames TLC1-TLCn encoded using backward prediction coding mode. The use of backward prediction coding mode forces both the encoder and the decoder to save a number of decoded pictures in a buffer (the DPB) because of the mismatch between the coding/decoding order and the display order. Since the DPB has a limit related to memory buffer constraints, so does the maximum number of frames that can be encoded using backward prediction. This is illustrated in diagram FIG. 4. The experiments showed that the most significant benefits happen in the initial frames (first 2-4 frames) TLC1-TLC4 of the TLC activity. Therefore, the DPB limit may not significantly affect the benefits of this method.

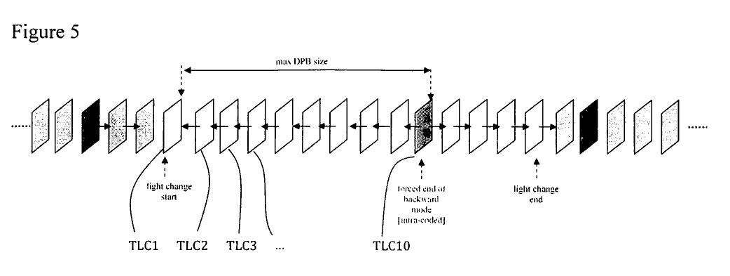

The second limit is introduced by the maximum GOP size. If a GOP reaches the maximum size while a TLC activity has started but not yet finished, then backward prediction coding mode is forced to end with the end of the GOP. For the frames still detected as TLC frames but assigned to the new GOP, there are two possible ways to proceed. Forward prediction coding mode can be forced for the rest of frames of the current TLC activity or a new backward prediction series of frames can be assigned starting from the frame that follows the IDR of the new GOP. FIG. 5 shows the first approach. Again, since the most significant gains in subjective video quality occur in the initial TLC frames (in display order) TLC1-TLC4, not much can be gained if the frames after a GOP boundary TLC6 are backward predicted in a new independent TLC activity.

Finally, we note that most implementations will use only P frames, and not B frames for encoding TLC frames. Use of certain described techniques in B frames is complicated due to the bi-prediction inherent in this type of frame. If B frames are used, some macroblocks may use reference macroblocks from frames with different light intensity potentially causing a visual mosaic artifact in the reconstructed video. Some implementations may, of course, also use B frames.

We thus provide one or more implementations having particular features and aspects. However, features and aspects of described implementations may also be adapted for other implementations. Although implementations described herein may be described in a particular context, such descriptions should in no way be taken as limiting the features and concepts to such implementations or contexts.

The implementations described herein may be implemented in, for example, a method or process, an apparatus, or a software program. Even if only discussed in the context of a single form of implementation (for example, discussed only as a method), the implementation or features discussed may also be implemented in other forms (for example, an apparatus or program). An apparatus may be implemented in, for example, appropriate hardware, software, and firmware. The methods may be implemented in, for example, an apparatus such as, for example, a computer or other processing device. Additionally, the methods may be implemented by instructions being performed by a processing device or other apparatus, and such instructions may be stored on a computer readable medium such as, for example, a CD, or other computer readable storage device, or an integrated circuit. Further, a computer readable medium may store the data values produced by an implementation.

As should be evident to one of skill in the art, implementations may also produce a signal formatted to carry information that may be, for example, stored or transmitted. The information may include, for example, instructions for performing a method, or data produced by one of the described implementations.

Additionally, many implementations may be implemented in one or more of an encoder, a pre-processor to an encoder, a decoder, or a post-processor to a decoder. The implementations described or contemplated may be used in a variety of different applications and products. Some examples of applications or products include set-top boxes, cell phones, personal digital assistants (PDAs), televisions, personal recording devices (for example, PVRs, computers running recording software, VHS recording devices), camcorders, streaming of data over the Internet or other communication links, and video-on-demand.

Further, other implementations are contemplated. For example, additional implementations may be created by combining, deleting, modifying, or supplementing various features of the disclosed implementations.

The following list provides a short list of various implementations. The list is not intended to be exhaustive but merely to provide a short description of a small number of the many possible implementations.

1. A new coding approach for frames containing certain light changes, which uses backward prediction coding mode to improve quality and reduce artifacts.

2. Implementation 1 where the last frame in a detected light change activity is coded using only intra-coding modes to improve the prediction of this frame.

3. A new GOP pattern selection which uses light change detection information to effectively select forward or backward prediction to be employed in the frames involved in such light changes.

4. Implementations 1 and/or 2 where the light changes are those starting with either a strong light intensity condition followed by a progressive reduction of light intensity revealing the visual content or the reverse, that is starting with a very low light intensity followed by a progressive increase of light intensity that reveals the visual content of the particular scene (also known as fade in and flash in respectively).

5. Implementations 1 and/or 2 with a limit on the maximum number of frames using backward prediction, based on the maximum number of frames allowed in the GOP and the buffer limit for the decoded picture buffer (DPB).

6. A signal produced from any of the implementations described in this disclosure.

7. Creating, assembling, storing, transmitting, receiving, and/or processing video coding information according to one or more implementations described in this disclosure.

8. A device (such as, for example, an encoder, a decoder, a pre-processor, or a post-processor) capable of operating according to, or in communication with, one of the described implementations.

9. A device (such as, for example, a computer readable medium) for storing one or encodings, or a set of instructions for performing an encoding, according to one or more of the implementations described in this disclosure.

10. A signal formatted to include information relating to an encoding according to one or more of the implementations described in this disclosure.

11. Implementation 10, where the signal represents digital information.

12. Implementation 10, where the signal is an electromagnetic wave.

13. Implementation 10, where the signal is a baseband signal.

14. Implementation 10, where the information includes one or more of residue data, motion vector data, and reference indicator data.

Experiments show that this combined technique yields significant improvement in perceptual video coding quality for such frames. The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

1. A method of encoding a series of video frames comprising:
detecting a light change pattern in the series beginning with an extreme light frame;
buffering the series of frames;
selecting an end light change frame in the series, the end light change frame having more information content than the extreme light frame; and
encoding frames backward from the end of light change frame to the extreme light frame.

2. The method of claim 1 wherein the extreme light frame is a substantially black frame.

3. The method of claim 1 wherein the extreme light frame is a substantially white frame.

4. The method of claim 1 wherein the end light change frame is coded by an intra-coding mode.

5. The method of claim 1 wherein the number of frames buffered depends upon the size of a buffer.

6. The method of claim 1 wherein the number of frames buffered depends upon a maximum number of frames allowed in a group of pictures.

7. An apparatus adapted to generate or receive a signal comprising a series of encoded video frames; encoded by detecting a light change pattern in the series beginning with an extreme light frame; selecting an end light change frame in the series, the end light change frame having more information content than the extreme light frame; and encoding the frames backward from the end of light change frame to the extreme light frame.

8. The apparatus of claim 7 wherein the signal represents digital information.

9. The apparatus of claim 7 wherein the signal is an electromagnetic wave.

10. The apparatus of claim 7 wherein the signal is a baseband signal.

11. A device capable of encoding video frames comprising:
a pre-analysis module having a light change detection apparatus;
an encoding module having a group of pictures (GOP) pattern decision sub-module which establishes a coding order and a display order for the frames belonging to the GOP such that, a backward prediction coding order is set for frames detected by the pre-analysis module as having a light change.
